(19) United States
(12) Patent Application Publication
(10) Pub. No.: US 2025/0290009 A1
(43) Pub. Date: Sep. 18, 2025

(54) NEW LOW SULFUR TERPENE MIX RECOVERY FROM WOOD PROCESSING

(71) Applicant: Firmenich SA, Satigny (CH)

(72) Inventors: Emmanuel CAZEILS, Dax (FR); Claudio RIVIER, Satigny (CH); Sébastien NAVARRE, Dax (FR)

(21) Appl. No.: 18/861,193

(22) PCT Filed: May 8, 2023
(86) PCT No.: PCT/EP23/62149

§ 371 Date: Oct. 28, 2024

(30) Foreign Application Priority Data
May 9, 2022 (EP) 22172273.9

(51) Int. Cl. C11B 9/02

(52) U.S. Cl. CPC C11B 9/027

(57) ABSTRACT

Disclosed herein is an eco-friendly liquid wood extract including terpenic compounds. Also disclosed herein is a perfumery, cosmetic, pharmaceutic, nutraceutical, antimicrobial, agrochemical or chemical ingredient obtained by the use the eco-friendly liquid wood extract. Also disclosed herein is a process for preparing an eco-friendly liquid wood extract.

### TECHNICAL FIELD

The present invention relates to the field of Perfumery, Flavors and ingredients for Industry. More particularly, it concerns valuable new natural and solvent free terpene intermediates mix for producing perfuming, flavor and/or industrial ingredients.

### BACKGROUND

Wood represents a valuable alternative for generation of building blocks for chemistry. It is a renewable resource that can potentially be used as a raw material for many products manufactured by the chemical industry. Unfortunately, for a vast majority of woodworking industries (pulping, fiberboard including medium and high density fiberboard (MDF and HDF), plywood, particle boards, Oriented strand boards (OSB), lumber, laminated strand boards, wood-based biofuels such as wood pellets, bioethanol . . . ) most of residues are collected in the wastes and not valorized. The need of reducing ecological impact of wood processing generates new opportunities for the wood industry to develop a cost-effective and ecofriendly waste reduction approach to maximize the yield of extraction of valuable compounds from wood.

Examples of valuable wood compounds are lignin, cellulose, hemicellulose, but also, terpenes. Typically, monoterpenes such as alpha-pinene, beta-pinene and dipentene represent skeletons highly desirables which could be used as such or as key intermediates to prepare more complex compounds in different fields such as, among others, perfumery, cosmetic, pharmaceutic and/or agrochemistry. Examples of ingredients obtained from alpha and beta-pinene and dipentene are synthetic odorants imparting an odor similar to sandalwood oil (such as SANDEROL®, EBANOL® or POLYSANTOL®/NIRVANOL®), or woody ingredients imparting cedar and/or amber note to fragrances and perfume formulations (such as SYLVAMBER®) or industrial compounds such polyterpenes resins (such as DERCOLYTE® grades A, M, L and S). More and more interests are also converging to compounds of higher molecular weight such as terpenic alcohol used for synthetize fragrances. Typically, Cis-pinanol is a terpenic alcohol that is pyrolyzed to make industrial quantities of linalool. Sesquiterpenes are valuable high molecular weight compounds used as building block for bio-polymers or as active ingredients in pharmaceutic compositions. Examples of valuable sesquiterpenes are alpha-cedrene widely used in fragrance formulation and the synthesis of more valuable aromatic substances, such as acetyl cedrene, cedryl ketone; beta-caryophyllene used in soaps and detergents or as raw material to synthesize other fragrances. The last example is longifolene, widely used in perfume industry but also as raw material for synthetic fragrances or in organic synthesis for the preparation of dilongifolylborane and isolongifolene and finally as floating agent for lead-zinc ore.

Terpenes can be extracted from tapping industry by first tapping live trees, collecting oleoresin with a final distillation of the gum obtained to separate the gum turpentine (GT) from the gum rosin. GT is typically a highly concentrated sulfur-free mixture of non-oxygenated monoterpenes but with very low presence of higher-molecular weight terpenic compounds such as terpene alcohols and sesquiterpenes.

Despite improvements in techniques providing better recovery yields, collecting oleoresin remained too labour intensive, resulting in a global reduction of this activity. There is thus a need to find new sustainable sources of terpenes.

The extractives of wood and notably terpenic compounds can be found in the heartwood and in the bark. The extractives content of bark is quite high compared to wood, but values reported in the literature can be very different even for the same species and would highly depend on the method of extraction.

Mostly, in the wood, a majority of the extractives in both softwoods and hardwoods are located in the heartwood. Both the bark and the wood contain carbohydrate and lignin. Composition and content of such carbohydrates and lignin will have a strong incidence on accessibility of extractives, on stringency of extraction processes and thus on extraction yield, composition of the extract obtained notably abundance of valuable compounds (terpenes and other terpenic compounds) and the ease of preparation or purification steps needed before their use as precursor or ingredient.

In general, softwoods have a higher cellulose content (40-45%), higher lignin (26-34%), and lower pentosan (7-14%) contents as compared to hardwoods (cellulose 38-49%, lignin 23-30%, and pentosans 19-26%).

In addition, lignin does not have a single repeating unit like cellulose but consists of a complex arrangement of substituted phenolic units creating a crosslinked structure more resistant to high temperature and pressure during pulping. The softwood lignin is slightly different than hardwood lignin with a methoxyl content of 15-16% while hardwood lignin has a methoxyl content of 21%. However, increased content of methoxyl groups in the lignin was found to correlate with decreased softening temperature of wet wood during pulping.

In the kraft pulping industry, terpenic compounds are extracted as a stream from the wood pulp and named Crude Sulfate Turpentine (CST). The CST is a complex mixture comprising monoterpenes, oxygenated monoterpenes, sesquiterpenes, higher molecular-weight terpenic compounds, aromatic phenolic compounds with a significant concentration of sulfur compounds (typical ranges from 8000 to 40000 ppm). Sulfur compounds are generated due to the use of sodium soda and sodium sulfide solutions—so-called white liquor, with wood chips under stringent conditions such as typical temperature until 180° C. and pressure that can reach 10×10⁵ Pa for durations of 60-240 minutes. Typical sulfur compounds are methylmercaptan, dimethylsulfide, dimethydisulfide and thiophene. These compounds being highly inflammable and toxic, they contribute to hazardous risks for production, storage and shipments of CST.

High-molecular weight terpenic compounds are present in CST in quite significant concentrations. It is due to the combination of two interdependent factors: the wood species used as raw material, and the stringent kraft pulping operating conditions. The higher the wood lignin concentration, the stringent the operating conditions will be for pulping the wood. Kraft pulping operating conditions involve partial and/or total vaporization of high-molecular weight terpenic compounds that are then also recovered with non-oxygenated monoterpenes to produce CST. Typical valuable high-molecular weight terpenic compounds are terpene alcohols such as notably alpha-terpineol or estragole and sesquiterpenes such as caryophyllene or longifolene.

Stringent conditions of kraft pulping aiming first at removing lignin from carbohydrates, generate high concentrations of wood biomass thermal degradation compounds. Typically, cellulose-derived decomposition products, hemicellulose-derived decomposition products and lignin-derived decomposition products are generated among which aromatic phenolic chemicals such as guaiacol, syringol, para-hydroxyphenolic. However, such compounds and particularly aromatic phenolic chemicals can only be partially removed from CST and increase the complexity of its composition.

The enrichment in valuable terpenic compounds and removal of all sulfur derivates are a prerequisite for any use in the manufacture of ingredients in the F&F Industry. Therefore, the high sulfur content combined with the complexity of the CST composition (with notably the aromatic phenolic chemicals from lignin degradation) does impact significantly safety, productivity and costs of a prior purification process to isolate valuable monoterpenes or sesquiterpenes derivatives from CST to be used in F&F industry. Such industrial separation process is even more complicated, see not economically viable regarding terpenic compounds of higher molecular weight such as caryophyllene, longifolene and alpha-terpineol.

Consequently, both of the wood species and the pre-treatment conditions of wood used by the wood-based industries or the forest biorefineries would have a strong impact on the quality of the final product(s) namely the main products (paper, fibreboard, particle boards, . . . ) but also the potential other extractives to valorise such as monoterpenes or other higher molecular weight terpenic derivatives as sesquiterpenes.

The extensive use of chemicals, water and steam not only generates a substantive amount of waste water contaminated with chemicals (from wood such as volatile organic compounds or synthetics chemicals) but also induces contamination of any valuable compounds extracted from the wood.

As awareness of climate and environment issues increases and consumption habits change, new opportunities are opening up for the wood or forest industry to develop cost effective functional green solutions by reducing ecological impact of wood processing but also by providing greener products to meet consumers' needs. Typically, the main challenge faced by wood industries is to reduce the use of chemicals in wood processes, reduce the content of residues notably terpenic compounds released in the environment or contained in final products.

Considering the high customer demands for renewable compounds or of compounds from natural origins, and current situations of industrial turpentine production, there is a need of a high quality solvent free, sulfur-free terpenes rich mixes to be used without extensive pretreatment as raw material for developing bio sourced ingredients notably in the F&F industry. There is consequently an increased need to develop ecofriendly, cost effective and solvent free processes allowing the recovery of such terpenes rich mixes.

The purpose of the invention is to provide a high quality solvent free, sulfur free terpenes rich mixes and an eco-friendly cost-effective wood pre-treatment process applicable to various wood based industries such as pulping industries, MDF and HDF industry or biofuel industry.

### SUMMARY OF THE INVENTION

In a first aspect, the present invention relates to liquid wood extract comprising:
a) between 50 and 95% (wt %) of at least one non-oxygenated monoterpene,
b) between 5 and 30% (wt %) of at least one terpene of higher molecular-weight than non-oxygenated monoterpenes,
c) less than 0.1% (wt %) of at least one wood biomass thermal degradation compound,
d) a sulfur content of less than 1000 ppm

In a second aspect, the present invention relates to process for producing a liquid wood extract comprising
a. providing wood logs mix comprising hardwood and softwood, with more than 50% of softwood, typically more than 70%
b. cutting or chipping or shredding the wood logs in strands or chips
c. applying a first steam treatment on the wood strands or chips in such a way that the steam is passed over the wood stands or chips at a temperature between 50° C. and 120° C. and a pressure between 0.1×10⁵ Pa and 4×10⁵ Pa,
d. applying a first compression step of the wood strands or chips at a pressure of between 7×10⁵ Pa and 15×10⁵ Pa and by adding water to the wood strands or chips at a temperature of between 10 to 40° C., to obtain pre-softened wood strands or chips, a first compression extract is collected,
e. Applying an evaporation step to the first compression extract by evaporating more than 15% of the first compression extract to generate a steam enriched in terpenic compounds
f. condensing the steam enriched in terpenic compounds, optionally combined with steam collected from the first steam treatment process, to obtain a condensed phase
g. applying a separation phase to said condensed phase by treating the condensed phase by gravimetry decantation and/or centrifugation to obtain a liquid wood extract.

Another object of the invention is a process for obtaining a perfumery, cosmetic, pharmaceutic, nutraceutical, antimicrobial agrochemical and/or chemical ingredient comprising the step of obtaining a liquid wood extract according to the process of the invention

Another object of the invention is the use of the liquid wood extract of the invention as an active compound in perfumery, cosmetic, pharmaceutic, nutraceutical, antimicrobial agrochemical and/or chemical compositions or for obtaining an active compound for perfumery, cosmetic, pharmaceutic, nutraceutical, antimicrobial, agrochemical and/or chemical compositions.

### DESCRIPTION OF THE INVENTION

A first object of the invention is a liquid wood extract comprising:
a) between 50 and 95% (wt %) of at least one non-oxygenated monoterpene, preferably between 70 and 94%, even more preferably between 80 and 93% (wt %) or 80 to 92% (wt %),
b) between 5 and 30% (wt %) of at least one terpene of higher molecular-weight than non-oxygenated monoterpenes, preferably between 5 and 20% (wt %), preferably between 6 and 20% (wt %), even more preferably between 7 and 15% (wt %),
c) less than 0.1% (wt %) of at least one wood biomass thermal degradation compound, preferably less than 0.05 (wt %), more preferably less than 0.001% (wt %)
d) a sulfur content of less than 1000 ppm, preferably less than 200 ppm, or less than 100 ppm, typically less than 80 ppm, even more preferably less than 50 ppm

The expression “liquid wood extract” refers to wood-based liquid extract, a liquid composition/mixture extracted from wood or obtained from a wood processing or by wood processing industries. In particular, the liquid composition/mixture is a waste stream in the wood industry producing fiberboard, plywood, particle boards, oriented strand boards, lumber, laminated strand boards or wood-based biofuels industries, in particular waste of fiberboard industry. The liquid wood extract may be recovered from liquid wastes generated during the transformation of the wood material.

For the sake of clarity, the term “terpene” or “terpenic compound” refers to any compound made up of two or more isoprene (C5) units. The term “terpene” includes compounds comprising only unmodified isoprene units, as well as compounds comprising one or more modified isoprene units (such as oxidation or rearrangement of the carbon skeleton). Such modified terpene compounds can also be referred to as “terpenoids” or “isoprenoids”. The number of C-atoms present in the terpene is typically evenly divisible by five (e.g. C10, C15, C20, C25, C30 and C40). Irregular terpenes have been reported, and are also included in the definition of “terpene”. Terpenes include, but are not limited to, monoterpenes (C10), sesquiterpenes (C15), diterpenes (C20), sesterterpenes (C25), triterpenes (C30), tetraterpenes (C40), and polyterpenes having longer chains of isoprene units. A terpene may be linear or cyclic.

Terpenes or terpenic compounds comprise oxygenated terpenes and non-oxygenated terpenes. Oxygenated terpenes have a terpene skeleton and an oxygen containing functional group. Non-oxygenated terpenes have an hydrocarbon skeleton without an oxygen functional group. Advantageously, non-oxygenated monoterpenes have a molecular weight of 132 to 140 g/mol. Typically, examples of oxygen functional groups are aldehydes, phenols, carboxylic acids, ketones, epoxides, acids, ethers, hydroxy groups and esters.

Terpenes of higher molecular-weight than non-oxygenated monoterpenes has a molecular-weight of more than 140 g/mol, preferably more than 148 g/mol, even more preferably between 148 to 600 g/mol, typically between 200 and 400 g/mol. Non limitative examples of “terpenes of higher molecular-weight than non-oxygenated monoterpenes” are oxygenated monoterpenes, diterpenes, sesquiterpenes, oxygenated sesquiterpens, sesterterpenes, triterpenes, tetraterpenes, polyterpenes and preferably, are selected from oxygenated monoterpenes, diterpenes and sesquiterpenes.

The term “monoterpene” refers to a compound made up of two isoprene units. The term “monoterpene” includes compounds comprising only unmodified isoprene units, as well as compounds comprising one or more modifications as described above. When the monoterpene includes such a modification, it can also be referred to as a “monoterpenoid”. Monoterpenes comprises oxygenated monoterpenes having a monoterpene skeleton and an oxygen containing functional group and non-oxygenated monoterpenes having an monoterpene skeleton without an oxygen functional group.

Preferably, the monoterpenes are acyclic (particularly linear), monocyclic or bicyclic.

According to the invention the at least one non-oxygenated monoterpenes is selected from a bicyclic non-oxygenated monoterpene, a monocyclic non-oxygenated monoterpene, an acyclic non-oxygenated monoterpene and mixtures thereof.

Non-limitative examples of acyclic non-oxygenated monoterpene are myrcene, ocimene, allo-ocimene, and citronellene.

Non-limitative examples of Monocyclic non-oxygenated monoterpene are Limonene (D-limonene, DL-limonene, dipentene), Isolimonene, p-Menthane, 1-p-Menthene, 3-p-Menthene, α-Terpinene, γ-Terpinene, Terpinolene, α-Phellandrene, β-phellandrene, p-Cymene, each in the form of any one of theirs stereoisomers or a mixture thereof.

For the sake of clarity, by the expression “each in the form of any one of their stereoisomers or a mixture thereof”, or the similar, it is meant the normal meaning understood by a person skilled in the art, i.e. that the compounds cited in the present invention such as monoterpene, terpenes or others typically Limonene or α-Pinene can have one or more stereocenters and so be a pure enantiomer or diastereomer. In other words, the compounds cited in the present invention may possess one or several stereocenters and each of said stereocenter can have two different stereochemistries (e.g. R or S). The compounds cited in the present invention may even be in the form of a pure enantiomer or in the form of a mixture of enantiomers or diastereoisomers. The compounds cited in the present invention can be in a racemic form or scalemic form. Therefore, the compounds cited in the present invention can be one stereoisomers or in the form of a composition of matter comprising, or consisting of, various stereoisomers.

Non-limitative examples of Bicyclic non-oxygenated monoterpenes are α-Pinene, β-Pinene, (±)-Camphene, delta-3-Carene, bornylene, sabinene, thujene, Carane, each in the form of one of their stereoisomers or a mixture thereof.

Preferably according to the invention, the preferred non-oxygenated monoterpene is selected from alpha-pinene, beta-pinene, dipentene and mixtures thereof, more preferably alpha pinene, beta pinene, each in the form of any one of their stereoisomers or a mixture thereof.

Typically, the at least one oxygenated monoterpene is selected from monoterpene alcohols, monoterpene aldehydes, monoterpene ketones, monoterpene epoxides, monoterpene ethers, and mixtures thereof. Preferably, the oxygenated monoterpenes are selected from monoterpene alcohols, monoterpene aldehydes, monoterpene ketones, monoterpene epoxides, and mixtures thereof. Preferably, the oxygenated monoterpenes are selected from monoterpenes alcohols, monoterpene epoxides and mixtures thereof.

Non-limitative examples of Acyclic Monoterpene Alcohols and Aldehydes are Geraniol, Nerol, (+)-Citronellol, (−)-Citronellol, Citral, (+)-Citronellal, (−)-Citronellal, Hydroxycitronellal, Linalool, myrcenol, Dihydromyrcenol and each in the form of any one of their stereoisomers or a mixture thereof.

Non-limitative examples of Acyclic Monoterpene ester are Linalyl Acetate and any one of their stereoisomers or a mixture thereof.

Non-limitative examples of Monocyclic Monoterpene Aldehyde are Perillaldehyde, Phellandral, 1,2-Dihydrophellandral, Cuminaldehyde and each in the form of any one of their stereoisomers or a mixture thereof.

Non-limitative examples of Monocyclic Monoterpene Alcohol are Menthol, Neomenthol, (+)-Isomenthol, Isopulegol, α-Terpineol, β-Terpineol, γ-Terpineol, (−)-Terpinen-4-ol, Thymol, Carvacrol, Carveol, Dihydrocarveol, Piperitenol, Isopiperitenol, Perillyl Alcohol, Carvomenthol and each in the form of any one of their stereoisomers or a mixture thereof.

Non-limitative examples of Monocyclic Monoterpene ether are Thymol Methyl Ether, Carvacrol Methyl Ether and any one of its stereoisomers or a mixture thereof.

Non-limitative examples of Monocyclic Monoterpene Ketone more particularly, α, β-Unsaturated Ketone are Carvone, Carvotanacetone, α-ionone, β-ionone, and γ-ionone Piperitone, Pulegone, Piperitenone Isopiperitenone and each in the form of any one of their stereoisomers or a mixture thereof.

Non-limitative examples of Monocyclic Monoterpene Saturated Ketone are Dihydrocarvone, Menthone, Isomenthone and each in the form of any one of their stereoisomers or a mixture thereof.

Non-limitative examples of Cyclic Monoterpene Epoxide are 1,8-Cineole, 1,4-Cineole and each in the form of any one of their stereoisomers or a mixture thereof

Non-limitative examples of Bicyclic Monoterpene Aldehyde are Myrtenal, Myrtanal and each in the form of any one of their stereoisomers or a mixture thereof.

Non-limitative examples of Bicyclic Monoterpene Alcohol are Myrtenol, Myrtanol, Pinocarveol, Pinane-2,3-Diol, Isopinocampheol (3-Pinanol), Borneol, Isoborneol, Fenchol, Verbenol, Nopol, and each in the form of any one of their stereoisomers or a mixture thereof.

Non-limitative examples of Bicyclic Monoterpene esters are Fenchyl Acetate, and each in the form of any one of their stereoisomers or a mixture thereof.

Non-limitative examples of Bicyclic Monoterpene ether are Nopol Benzyl Ether and each in the form of any one of their stereoisomers or a mixture thereof.

Non-limitative examples of Bicyclic Monoterpene Ketones and more particularly Unsaturated ketone are Verbenone, Pinocarvone and each in the form of any one of their stereoisomers or a mixture thereof.

Non-limitative examples of Bicyclic Monoterpene Saturated Ketone are Camphor, Fenchone, alpha-Thujone, beta-Thujone, 3-Pinanone (Pinocamphone and Isopinocamphone), 2-Hydroxy-3-Pinanone and each in the form of any one of their stereoisomers or a mixture thereof.

Advantageously, terpenes of higher molecular-weight than non-oxygenated monoterpenes are oxygenated monoterpenes, diterpenes, sesquiterpenes and mixtures thereof.

The preferred oxygenated monoterpene is selected from monoterpenes alcohols, monoterpenes aldehydes, monoterpenes ketones, monoterpene epoxides and mixtures thereof.

Preferred oxygenated monoterpenes are terpenes alcohols such as terpineol, estragole, anethole, borneol and each in the form of any one of their stereoisomers or a mixture thereof.

Terpineol exists as different regioisomers, which all are considered terpineols. The terpineol is selected from the group consisting of alpha-terpineol, beta-terpineol, gamma-terpineol, delta-terpineol, 4-terpineol [or (−)-Terpinen-4-ol], each in the form of any one of their stereoisomers or a mixture thereof. More preferably, the terpineol is selected from the group consisting of alpha-terpineol, beta-terpineol, gamma-terpineol, delta-terpineol, each in the form of any one of their stereoisomers or a mixture thereof.

The term “diterpene” refers to a compound made up of four isoprene units. The term “diterpene” includes compounds comprising only unmodified isoprene units, as well as compounds comprising one or more modifications as described above When the monoterpene includes such a modification, it can also be referred to as a “diterpenoid.” The liquid wood extract of the invention advantageously comprises at least one diterpene, a cyclic diterpene, typically at least one dicyclic diterpene and/or at least one tricyclic diterpene.

Typically said diterpene is a non-oxygenated or an oxygenated diterpene, preferably an oxygenated diterpene.

Examples of oxygenated diterpenes are diterpene acids typically tricyclic diterpene acids, bicyclic diterpene acids or mixtures thereof.

Non limitative examples of oxygenated diterpenes are tricyclic diterpene acids selected from abietic, dehydroabietic, isopimaric, levopimaric, neoabietic, palustric, pimaric, sandaracopimaric acids each in the form of any one of their stereoisomers or a mixture thereof.

Non limitative examples of oxygenated diterpenes are bicyclic diterpene acids selected from agathic, isocupressic, trans-communic acids each in the form of any one of their stereoisomers or a mixture thereof.

According to the invention, non-limitative examples of diterpenes or diterpenoids are abietane, rosin, rosinane, daphnane, arteane, cassane, podocarboxane, taurane, labdane, isoabienol and each in the form of any one of their stereoisomers or a mixture thereof, preferably abietane Rosin, rosinane, isoabienol, podocarboxane and each in the form of any one of their stereoisomers or a mixture thereof.

Example of labdane-type diterpenoids are abietadiene, abieta-8(14), 13(15)-diene; (Z)-biformene; isoabienol labda-7,14-dien-13-ol, labda-7,13,14-trien; manool, manoyl oxide 13 epi monoyl oxide and each in the form of any one of their stereoisomers or a mixture thereof.

The sesquiterpenes are preferably acyclic sesquiterpenes, cyclic sesquiterpenes and mixtures thereof.

Preferably, the acyclic sesquiterpenes acyclic is farnesene. The cyclic sesquiterpenes is selected from cuparene, curcumene, longifolene, longicyclene, longipinene, caryophyllene, humulene, murolene, α-copaene, β-copaene, bisabolene each in the form of any one of their stereoisomers or a mixture thereof.

The preferred sesquiterpenes are selected from farnesene, longifolene, longicyclene, longipinene caryophyllene, humulene, murolene, alpha-muurolene; each in the form of any one of their stereoisomers or a mixture thereof.

Non limitative examples of oxygenated sesquiterpenes are caryophyllene oxide and any one of its stereoisomers or a mixture thereof.

Non limitative examples of sesterterpenes, are ophiobolines and any one of its stereoisomers or a mixture thereof. Non-limitative examples of triterpenes, are squalanes, hopanes, sterols and each in the form of any one of their stereoisomers or a mixture thereof. Non limitative examples of tetraterpenes, are carotanes and each in the form of any one of their stereoisomers or a mixture thereof. A non-limitative example of polyterpenes is natural rubber.

By “Wood biomass thermal degradation compounds” it should be understood compounds generated during exposure of wood biomass and more particularly cellulose, hemicellulose and lignin at temperature above 200° C. Such degradation compounds and more particularly cellulose-derived decomposition products, hemicellulose-derived decomposition products and lignin-derived decomposition products have been extensively studied by scientific literature (Pyrolysis of Cellulose, Kunio Katō, Agr. Biol. Chern., Vol. 31, No.6, p. 657˜663, 1967; Recent Insights into Lignocellulosic Biomass Pyrolysis: A Critical Review on Pretreatment, Characterization, and Products Upgrading, Z E Zadeh et al; Processes 2020, 8, 799; Hydrothermal liquefaction of wood using a modified multistage shrinking core model, M. Jayathilakea et al; Fuel 280 (2020) 118616).

A cellulose-derived decomposition product is any of hydroxymethyl furfural, levoglucosan, cellobiose, anhydroglucose derivatives, acetaldehyde, methanol, glyoxal, acrolein each in the form of any one of their stereoisomers or a mixture thereof.

A hemicellulose-derived decomposition product is a furan or furan derivatives, notably any of furan, furfuraldehyde (also called furfural), furfuryl alcohol.

A lignin-derived decomposition product contains phenols typically phenol, cresol, catechol, eugenol, methyleugenol guaiacol, 4-propylphenol, 4-ethylguaiacol, methyleugenol, syringol, p-hydroxyphenolic hydroxy methoxy toluene, hydroxy methoxy ethyl benzene, hydroxy methoxyvinyl benzene, hydroxy methoxy propyl benzene, dimethoxy phenol, hydroxy dimethoxy toluene, hydroxy dimethoxy ethyl benzene, hydroxy dimethoxy propyl benzene, pyrocatechol, benzofuran, dibenzofuran, and vanillin. Of these phenols, phenol and cresol are particularly industrially important compounds. The lignin-derived decomposition product to be obtained herein contains at least phenol or cresol.

Typically, the content of the at least one wood biomass thermal degradation compound in the liquid wood extract of the invention is between 0.0000001 and 0.1%, or between 0.0000001 and 0.05%, or between 0.0000001 and 0.1%, or between 0.0000001 and 0.001% (wt %).

Sulfur content means the total sulfur content of the extract. Typically the sulfur content is evaluated by Fluorescence UV on a Sulfur Analyser Antek Multitek NT-HS according to the norm ASTM D 5453. Advantageously, sulfur content is between 1000 ppm and 0.01 ppm, preferably between 200 ppm and 0.1 ppm, or between 100 ppm and 1 ppm, typically between 80 ppm and 2 ppm, even more preferably less than 50 ppm. Particularly, the liquid wood extract is free of sulfur compounds.

A Second object of the present invention is a process for producing a liquid wood extract comprising
a. providing wood logs mix comprising hardwood and softwood, with more than 50% of softwood, typically more than 70%,
b. cutting or chipping or shredding the wood logs in strands or chips,
c. applying a first steam treatment on the wood strands or chips in such a way that the steam is passed over the wood stands or chips at a temperature between 50° C. and 120° C. and a pressure between 0.1×10⁵ Pa and 4×10⁵ Pa,
d. applying a first compression step of the wood strands or chips at a pressure of between 7×10⁵ Pa and 15×10⁵ Pa and by adding water to the wood strands or chips at a temperature of between 10 to 40° C., to obtain pre-softened wood strands or chips, a first compression extract is collected,
e. Applying an evaporation step to the first compression extract by evaporating more than 15% of the first compression extract, preferably 20 to 80% of the first compression extract, even more preferably between 22 to 40%, typically between 25 and 35%, to generate a steam enriched in terpenic compounds
f. condensing the steam enriched in terpenic compounds, optionally combined with steam collected from the first steam treatment process, to obtain a condensed phase
g. applying a separation phase to said condensed phase by treating the condensed phase by gravimetry decantation and/or centrifugation to obtain a liquid wood extract.

According to the invention, the wood logs mix of hardwood and softwood comprises about 70 to 100% of softwood, preferably 75 to 98%, 80 to 95% or 85 to 90% of softwood.

“Softwood” should be understood as wood produced by angiosperm or conifer trees. None limitative examples of softwood are Araucaria; Cedar (Cedrus); Cypress (Chamaecyparis, Cupressus, Taxodium); Rocky Mountain Douglas-fir (Pseudotsuga menziesii var. glauca); European Yew (Taxus baccata); Fir (Abies); Hemlock (Tsuga): Eastern Hemlock (Tsuga canadensis), Mountain Hemlock (Tsuga mertensiana), Western Hemlock (Tsuga heterophylla); Kauri (New Zealand) (Agathis australis); Kaya (Torreya nucifera); Larch (Larix); Pine (Pinus); Spruce (Picea); Whitecedar and Yellow-cedar (Nootka Cypress Callitropsis nootkatensis, formerly Chamaecyparis nootkatensis); Redcedar; Redwood (Sequoia sempervirens) and Rimu (New Zealand) (Dacrydium cupressinum).

Typically the Cypress (Chamaecyparis, Cupressus, Taxodium) is selected from Arizona Cypress (Cupressus arizonica), Bald Cypress or Southern cypress (Taxodium distichum), Hinoki Cypress (Chamaecyparis obtusa), Lawson's Cypress (Chamaecyparis lawsoniana) and Mediterranean Cypress (Cupressus sempervirens).

Typically the Hemlock (Tsuga) is selected from, Eastern Hemlock (Tsuga canadensis), Mountain Hemlock (Tsuga mertensiana) and Western Hemlock (Tsuga heterophylla)

Typically the Larch (Larix) is selected from, European Larch (Larix decidua), Japanese Larch (Larix kaempferi), Tamarack Larch or Tamarack (Larix laricina), Western Larch (Larix occidentalis)

Typically the Pine (Pinus) is selected from, Corsican pine (Pinus nigra), Jack Pine (Pinus banksiana), Lodgepole Pine (Pinus contorta subsp latifolia), Monterey Pine (Pinus radiata), Ponderosa Pine (Pinus ponderosa), Red Pine (N. Am.) (Pinus resinosa), Scots Pine, Red pine (UK), Red deal (UK), Redwood (UK, obsolete) (Pinus sylvestris), White Pine (Yellow or Weymouth pine, Eastern White Pine (Pinus strobus), Western White Pine (Pinus monticola), Sugar Pine (Pinus lambertiana)), Southern Yellow pine (Loblolly Pine (Pinus taeda), Longleaf Pine (Pinus palustris), Pitch Pine (Pinus rigida), Shortleaf Pine (Pinus echinata)), Maritime pine (Pinus pinaster), Pinus elliottii—Slash pine (Pinus elliottii), Masson's pine (Pinus massoniana), Aleppo pine (Pinus halepensis) Sumatra Pine (Pinus merkusii) and Monterey pine, radiata pine (Pinus radiata).

Softwood of particular interest are more specifically Maritime pine (Pinus pinaster), Pinus elliottii—Slash pine (Pinus elliottii), Masson's pine (Pinus massoniana), Aleppo pine (Pinus halepensis) and Monterey pine, radiata pine (Pinus radiata).

Typically the Spruce (Picea) is selected from Norway Spruce (Picea abies), Black Spruce (Picea mariana), Red Spruce (Picea rubens), Sitka Spruce (Picea sitchensis), White Spruce (Picea glauca) and Sugi (Cryptomeria japonica).

Typically the Whitecedar is selected from Northern Whitecedar (Thuja occidentalis), Southern Whitecedar (Chamaecyparis thyoides).

Typically the Redcedar is selected from Eastern Redcedar, (Juniperus virginiana), Western redcedar (Thuja plicata)

Typically the Araucaria is selected from, Hoop Pine (Araucaria cunninghamii); Parana Pine (Araucaria angustifolia); Pehuén or Chile Pine (Araucaria araucana);

Typically the Cypress (Chamaecyparis, Cupressus, Taxodium) is selected from, Arizona Cypress (Cupressus arizonica), Bald Cypress or Southern cypress (Taxodium distichum), Hinoki Cypress (Chamaecyparis obtusa), Lawson's Cypress (Chamaecyparis lawsoniana), Mediterranean Cypress (Cupressus sempervirens)

According to the invention the wood log mix comprises 0 to 30%, preferably 2 to 25%, even more preferably 5 to 20% of hardwood logs.

For the sake of clarity, “Hardwood” means wood produced by angiosperms trees that have broad leaves and reproduce flowers. Hardwoods have broad leaves and enclosed nuts or seeds such as acorns. They grow in subtropical regions like Africa and also in Europe and other regions such as Asia. The dominant feature separating hardwoods from softwoods is the presence of pores, or vessels.

Non limitative examples of hardwood are Afzelia (Afzelia); Agba yun (Synsepalum duloificum); Albizia (Albizia); Alder (Alnus); Applewood or wild apple (Malus); Ash (Fraxinus); Aspen (Populus); Ayan (Distemonanthus benthamianus); Balsa (Ochroma pyramidale); Basswood (Tilia americana); Beech (Fagus); Birch (Betula); Blackbean (Castanospermum australe); Blackwood; Bocote (Cordia alliodora); Boxwood or Box (Buxus sempervirens); Brazilwood (Caesalpinia echinata); Bubinga (Guibourtia); Buckeye (Aesculus); Butternut (Juglans cinerea); Carapa (or Andiroba, Carap, Crappo, Crabwood and Santa Maria) (Carapa guianensis); Catalpa (Catalpa); Cherry (Prunus); Chestnut (Castanea dentata); Coachwood (Ceratopetalum apetalum); Cocobolo (Dalbergia retusa); Corkwood (Leitneria floridana); Cottonwood, eastern (Populus deltoides); Dogwood (Cornus spp.); Ebony (Diospyros); Elm; Eucalyptus (Eucalyptus); Greenheart (Guyana) (Chlorocardium rodiei); Grenadilla (Mpingo) (Dalbergia melanoxylon); Gum; Hickory (Carya); Hornbeam (Carpinus species); Hophornbeam, Eastern (Ostrya virginiana); Ipé or Poui (Tabebuia); Iroko (Milicia excelsa, syn. Chlorophora excelsa)

Typically the Beech (Fagus) is selected from European Beech (Fagus sylvatica), American Beech (Fagus grandifolia)

Typically the Birch (Betula) is selected from Gray birch (Betula populifolia), Paper birch (Betula papyrifera), Sweet birch (Betula lenta), Yellow birch (B. alleghaniensis syn Betula lutea), Silver birch (Betula pendula), White Birch (Betula pubescens)

Typically the Alder (Alnus) is selected from Black alder (Alnus glutinosa), Red alder (Alnus rubra)

Typically the Ash (Fraxinus) is selected from Black ash (Fraxinus nigra), Blue ash (Fraxinus quadrangulata), Common ash (Fraxinus excelsior), Green ash (Fraxinus pennsylvanica lanceolata), White ash (Fraxinus americana)

Typically the Aspen (Populus) is selected from American aspen (Populus tremuloides), Bigtooth aspen (Populus grandidentata), European aspen (Populus tremula)

Typically the Blackwood is selected from Australian Blackwood also Tasmanian Blackwood (Acacia melanoxylon), African Blackwood or Mpingo (Dalbergia melanoxylon)

Typically the Buckeye (Aesculus) is selected from Common Horse-chestnut (Aesculus hippocastanum), Yellow Buckeye (Aesculus flava)

Typically the Cherry (Prunus) is selected from Black cherry (Prunus serotina), Red cherry (Prunus pennsylvanica), Wild cherry (Prunus avium Prunus serotina), Brazilian

Cherry

Typically the Chestnut (Castanea dentata) is selected from Cape Chestnut (Calodendrum capense)

Typically the Ebony (Diospyros) is selected from Andaman marble-wood (India) (Diospyros kurzii), Ebène marbre (Mauritius, E. Africa) (Diospyros melanida), Gabon ebony, Black ebony, African ebony (Diospyros crassiflora)

Typically the Elm is selected from American elm (Ulmus americana), English elm (Ulmus procera), Rock elm (Ulmus thomasii), Slippery elm (Ulmus rubra), Wych elm (Ulmus glabra)

Typically the Eucalyptus (Eucalyptus) is selected from Lyptus, Karri (W. Australia) (Eucalyptus diversicolor), Mahogany eucalyptus (New South Wales) (Eucalyptus), Ironbark (Eucalyptus sideroxylon), Jarrah or West Australian eucalyptus (Eucalyptus marginate), Tasmanian oak or Mountain ash, (Eucalyptus regnans, Eucalyptus obliqua, Eucalyptus delegatensis), River Red Gum, Blue Gum (Eucalyptus saligna)

Typically the Gum is selected from Blackgum (Nyssa sylvatica), Blue gum (Eucalyptus globulus), Redgum or Sweetgum (Liquidambar styraciflua), Tupelo gum (Nyssa aquatica)

Typically, the Hickory (Carya) is selected from Mockernut hickory (Carya alba), Pignut hickory (Carya glabra), Shagbark hickory (Carya ovata), Shellbark hickory (Carya laciniosa).

Hardwood are particularly advantageous process wise firstly due to the presence of high contents of cellulose and lignin and secondly because of the presence of valuable heavier terpenic compounds. Unfortunately due to the low presence of non-oxygenated monoterpenes of interest, a content of hardwood logs over than 30% is not particularly advantageous for extraction of targeted monoterpenes mixes to be further purified through an economical viable process.

Indeed these species of softwood are particularly advantageous thanks to their typical turpentine chemical composition, showing a high presence of alpha-pinene and/or beta-pinene and/or dipentene

According to the process of the invention, the wood logs are cut, chipped, or shredded in strands, or chips. Typically, the size of the wood strands or chips have been demonstrated to improve the extraction process. It has been shown particularly advantageous to cut chip or shred wood with a length in the range from 50 to 200 mm, preferably from 70 to 180 mm, particularly preferably from 90 to 150 mm.

The terms “wood logs” refer to pieces of heartwood and/or bark [, i.e., the outermost layers of stems and roots of woody plants].

According to one optional embodiment, the wood strands or chips are pretreated with hot water at a temperature between 50° C. to 100° C., a pretreatment extract is collected or is optionally recycled for one or more batches of wood strands or chips before collection. The pretreatment has been shown to increase the extraction of monoterpenes. Typically, such pretreatment can be applied on part or totality of the wood batches. Advantageously, the pretreatment is applied during 10 to 60 minutes, preferably from 15 to 45 minutes, particularly preferably from 20 to 30 minutes.

According another optional embodiment of the invention, the wood strands or chips are not washed before the first steam treatment.

According to the invention, the first steam treatment is ideally performed between 50° C. and 120° C., particularly between 50° C. and 100° C. This range of temperature is particularly advantageous in that vaporization temperature of the monoterpenes of interest is between 150° C. and 170° C.

Typically, the first steam treatment is applied to the wood strands or chips in such a way that the steam is passed over the wood strands or chips to obtain a temperature between 60° C. and 110° C., preferably between 70° C. and 100° C. in particular typically about 80° C. and 90° C.

Typically, the first steam treatment is applied to the wood strands or chips in such a way that the steam is passed over the wood strands or chips at a pressure between 1×10⁵ Pa and 4×10⁵ Pa, particularly 1×10⁵ Pa and 3×10⁵ Pa, more particularly 1.5×10⁵ Pa and 3×10⁵ Pa and preferably of about 2×10⁵ Pa.

Advantageously, the combination of pressure and temperature during the first steam treatment starts the softening of the lignin and consequently of the softening of the wood strands or chips, allowing then to start the release of low-molecular-weight volatile compounds such as non-oxygenated monoterpenes.

Typically, the first steam treatment of the wood strands or chips is carried out over a period of 10 to 60 minutes, preferably 15 to 45 minutes, in particular 20 minutes.

The amount of steam applied during said first steam treatment is between 0.05 and 0.2 kg steam/kg wood strands or chips.

Preferably, the steam is a fresh steam and/or recycled steam from the downstream steps.

According to the invention the first compression step of the wood strands or chips is preferably applied at a pressure of between 8×10⁵ Pa and 14×10⁵ Pa, preferably 10×10⁵ Pa to 13×10⁵ Pa.

Advantageously, during the first compression step, water is introduced at 12 to 38° C., typically between 15 and 35° C., between 18 and 30° C., preferably, at about room temperature. Introducing the water at such temperatures was demonstrated to be of particular interest as it prevents the wood to overheat. The water is also used to transport out the system foreign material and liquids available typically terpenic compounds and aqueous. The first compression extract collected during this step is the first stream removing substantial terpenic compounds.

According any embodiments of the invention, the wood strands or chips are not cleaned after the first steam treatment and before the first compression step.

According to any one of the above embodiments of the invention, the process comprises a second steam treatment that is applied to the pre-softened wood strands or chips in such a way that the steam is passed over the pre-softened wood strands or chips at a temperature between 150° C. and 220° C.

According to any one of the above embodiments of the invention during the second steam treatment, the steam is applied to the pre-softened wood strands or chips at a pressure between 7×10⁵ Pa and 17×10⁵ Pa.

It is particularly advantageous to maintain the temperature below 220° C. to limit wood thermal degradation which will result in the formation of wood thermal degradation products.

Typically this combination of pressure and temperature will continue to soften wood strands or chips, allowing then to increase the release of volatile compounds. The second steam treatment is ideally performed at a temperature between 155° C. and 210° C., and more specifically between 160° C. and 190° C. Advantageously, the second steam treatment is ideally performed at a pressure between 8×10⁵ Pa and 15×10⁵ Pa, in particular preferably 9×10⁵ Pa to 14×10⁵ Pa. Any combination of the ranges of temperature and pressure above are envisageable.

Steam can be either fresh steam and/or recycled steam from any downstream steps.

Advantageously, the second steam treatment of the pre-softened wood strands or chips with the ranges of temperature and pressure above mentioned is carried out over a period of 1 to 30 minutes, preferably 5 to 10 minutes. The amount of steam is between 0.05 and 0.2 kg steam/kg wood strands or chips. The released vapors, in which monoterpenes are present, can then be recycled to the first steaming process step and/or sent directly to condensers (see hereinafter).

Advantageously, the steam released from the steam treatment step is recycled to the first steam treatment. This recycling is particularly advantageous for energy savings but also to further concentrate terpenic compounds within the steam.

According to the above embodiments of the invention, a second compression step is applied following the second steam treatment at a pressure of between 7×10⁵ Pa and 15×10⁵ Pa to obtain softened wood strands or chips and a second compression extract is collected.

Advantageously, the second compression step is applied at a pressure of between 9×10⁵ Pa to 14×10⁵ Pa, even more preferably 10×10⁵ Pa and 13×10⁵ Pa.

According to any one of the above embodiments of the invention, the second compression step is applied following the second steam treatment at a temperature comprised between 130° C. and 220° C. to obtain softened wood strands or chips and a second compression extract is collected, particularly at a temperature comprised between 140° C. and 200° C., particularly at a temperature comprised between 140° C. and 180° C., even more particularly at a temperature comprised between 150° C. and 170° C.

According to any one of the above embodiments of the invention, subsequent steam treatment(s) and compression steps are applied on the softened wood strands or chips to obtained deeply softened wood strands or chips and collect subsequent compression extract(s). Advantageously, the steam released from the subsequent steam treatment(s) is recycled to the first steam treatment and/or second steam treatment.

According to any one of the above embodiments of the invention, the process comprises a refining step applied by passing a steam over the pre-softened wood stands or chips or over the softened wood stands or chips or over the deeply softened wood strands or chips at a temperature between 150° C. and 220° C., typically at a pressure between 7×10⁵ Pa and 15×10⁵ Pa, preferably during less than 3 min, typically less than 2 min.

The term “refining” refers to a mechanical process of treating lignocellulosic-containing solids in order to beat, bruise, cut, and/or fibrillate the fibers therein. Refining refers both to the coarse separation of the fibers (defibration) and to working of the fibers (refinement in its true meaning). Thus, refining can be used to reduce lignocellulosic-containing solids in size as well as to providing material comprising bundles of cellulosic fibers, separate cellulosic fibers, fragments of cellulosic fibers, and combinations thereof. Such mechanical processing is preferably applied at temperature between 140° C. and 210° C., and more specifically between 160° C. and 190° C., at a pressure between 6×10⁵ Pa and 14×10⁵ Pa, in particular preferably 9×10⁵ Pa to 13×10⁵ Pa. The steam is typically applied during less than 2 min preferably less than 1 min. The duration of the refining step should be less than 3 min in order to limit any thermal wood degradation as it was described earlier.

Advantageously, the steam released from the refining step is recycled to the first steam treatment and/or second steam treatment.

According to any one of the above embodiments of the invention, the evaporation step is applied on a mix of compression extracts comprising the first compression extract and/or the second compression extract and/or on the subsequent compression extract(s) by evaporating more than 15% of the mix of compression extracts, preferably 20 to 80%, even more preferably between 22 to 40%, typically between 25 and 35% of mix of compression extracts.

Advantageously the first compression extract or the mix of compression extracts is centrifugated before the evaporation step. This centrifugation is particularly advantageous to remove solid materials released by the wood stands or chips.

Typically, the pressure applied during the evaporation step is between 0.2×10⁵ Pa and 1×10⁵ Pa, preferably between 0.5×10⁵ Pa to 1×10⁵ Pa (i.e. under medium vacuum) or at atmospheric pressure. The temperature of the mixture is maintained above water boiling point, typically due to the presence of dissolved compounds. Water boiling point temperature will be respectively for an evaporation pressure of between 0.2×10⁵ Pa and 1×10⁵ Pa, a temperature of between 65° C. and 105° C.; for an evaporation pressure between 0.5×10⁵ to 1×10⁵ Pa, a temperature of between 85° C. and 105° C.

Preferably the steam enriched in terpenic compounds, optionally combined with steam collected from the first steam treatment and/or the second steam treatment and/or the refining step is condensed to obtain a condensed phase.

The condensation step is done by any type of condenser capable to totally condense the vapor stream and leading to a two-phase liquid.

Advantageously, the released vapors from the first steam treatment and/or the second steam treatment step and/or the refining step are independently treated by a control system of condensers to obtain a subsequent condensed phase.

The condensed phase and/or the subsequent condensed phase are further treated by a separation phase by density differential (gravity decantation) or assisted gravity (centrifugation) to obtain the liquid wood extract of the invention.

This process is particularly advantageous in that it allows to remove terpenes from the aqueous stream that is usually sent to the waste water treatment unit, enabling consequently a more efficient and ecofriendly water treatment process.

According to any embodiment of the invention process, the invention process is perform in absence of any organic solvents, additives, synthetic or natural extraction agent and/or compressed air. Exclusively water and steam are used during the inventions process. The liquid wood extract of the present invention and obtained by the invention's process may be converted into a perfumery, cosmetic, pharmaceutic, nutraceutical, antimicrobial agrochemical and/or chemical ingredient. The person skilled in the art is well aware of method to convert the liquid wood extract of the present invention into a perfumery, cosmetic, pharmaceutic, nutraceutical, antimicrobial agrochemical and/or chemical ingredient. In particular, the liquid wood extract of the present invention may be converted into said ingredient without desulfurisation step.

This process is particularly advantageous in that it allows the preparation of a liquid wood extract comprising less than 0.1% (wt %) of at least one wood biomass thermal degradation compound and a sulfur content of less than 1000 ppm. The invention process allows to avoid purification steps. In other words, the liquid wood extract could be used as such.

A third object of the present invention is a process for obtaining a perfumery, cosmetic, pharmaceutic, nutraceutical, antimicrobial agrochemical and/or chemical ingredient comprising the step of obtaining a liquid wood extract according to the process of the invention.

A fourth object of the present invention is the use of the liquid wood extract of the invention as an active compound in perfumery, cosmetic, pharmaceutic, nutraceutical, antimicrobial, agrochemical and/or chemical compositions or for obtaining an active compound for perfumery, cosmetic, pharmaceutic, nutraceutical, antimicrobial, agrochemical and/or chemical compositions.

Another object of the present invention is a method to prepare a perfumery, cosmetic, pharmaceutic, nutraceutical, antimicrobial, agrochemical and/or chemical compositions or articles which method comprises adding to said composition or article an effective amount of the liquid wood extract of the invention as an active compound.

Another object of the present invention is a process for obtaining a perfumery, cosmetic, pharmaceutic, nutraceutical, antimicrobial agrochemical and/or chemical compositions or articles comprising the step of
a) obtaining a liquid wood extract according to the process of the invention; and
b) adding the liquid wood extract of step a) to the perfumery, cosmetic, pharmaceutic, nutraceutical, antimicrobial agrochemical and/or chemical compositions or articles.

According to a particular embodiment of the invention, the liquid wood extract of step a) is directly added into the perfumery, cosmetic, pharmaceutic, nutraceutical, antimicrobial agrochemical and/or chemical compositions or articles. In other words, the invention process does not comprise a purification step between step a) and b).

According to another particular embodiment of the invention, the liquid wood extract of step a) is purified by methods known by a person skilled in art such as distillation or rectification.

Another object of the present invention is a method to prepare an active compound for perfumery, cosmetic, pharmaceutic, nutraceutical, antimicrobial, agrochemical and/or chemical which method comprises one or more steps to convert the liquid wood extract of the invention into the active compound.

Another object of the present invention is a process for preparing a an active compound for perfumery, cosmetic, pharmaceutic, nutraceutical, antimicrobial, agrochemical and/or chemical compositions comprising the step of
a) obtaining a liquid wood extract according to the process of the invention; and
b) converting the liquid wood extract of step a) to the active compound for perfumery, cosmetic, pharmaceutic, nutraceutical, antimicrobial agrochemical and/or chemical compositions.

According to any embodiment of the invention, the liquid wood extract of step a) is directly converted into the perfumery, cosmetic, pharmaceutic, nutraceutical, antimicrobial agrochemical and/or chemical compositions or articles. In other words, the invention process does not comprise a purification step between step a) and b).

In particular, the “active compound” is selected from the group consisting of a perfuming ingredient, flavoring ingredient, nutraceutical ingredient, malodor counteracting ingredient, antimicrobial ingredient, cosmetic ingredient, insect repellent or attractant ingredient, chemical and/or agrochemical ingredient.

Therefore, to be considered as an “active compound” the compound has to possess at least one property which renders it useful as a perfuming ingredient, as a malodor counteracting ingredient, as a flavoring ingredient, as a cosmetic ingredient, as a nutraceutical ingredient, as an antimicrobial ingredient, as an insect repellent or attractant and/or as a chemical ingredient.

The term “perfuming ingredient” is understood as a compound which is used as an active ingredient in perfuming preparations or compositions in order to impart a hedonic effect. In other words, a compound to be considered as being a perfuming ingredient, must be recognized by a skilled person in the art of perfumery as being able to impart or modify in a positive or pleasant way the odor of a composition, and not just as having an odor. The perfuming ingredient may impart an additional benefit beyond that of modifying or imparting an odor, such as long-lasting, blooming, malodour counteraction, antimicrobial effect, antiviral effect, microbial stability, or pest control. The term “flavoring ingredient” is understood to as being capable of imparting a taste sensation to the taster's pallet. The term “malodor counteracting ingredient” is understood as being capable of reducing the perception of malodor, i.e. of an odor that is unpleasant or offensive to the human nose. The term “antimicrobial ingredient” is understood as being capable of killing microorganism or reducing or preventing their growth and/or accumulation and include antibacterial, antibiotic, antifungal, antiviral and antiparasitic ingredients. The term “insect attractant or repellent” is understood as a compound having a positive or negative effect on insects. Examples of insect attractant or repellent ingredients can be found in reference texts or in other works of a similar nature as for example: A. M. El-Sayed, The Pherobase 2005, http://www.pherobase.net.

The term “chemical ingredient” is understood as a compound which is used as an active ingredient in chemical processes as a raw material or as a building block in chemical synthesis.

Typically the adhesives, the liquid wood extract of the invention maybe used as an active compound in chewing-gum, inks, tires, bitumen composition or for obtaining thereof.

By way of definitions, “nutraceutical ingredient” refers to a component of food or other ingestible forms that have been determined to be beneficial to the human body in preventing or treating one or more diseases or improving physiological performance. Essential nutrients can be considered nutraceuticals if they provide a benefit beyond their essential role in normal growth or maintenance of the human body.

Unless stated otherwise, percentages (%) are meant to designate percent by weight (wt. %) of a composition.

Typical manners to execute the invention's process are reported herein below in the examples.

### EXAMPLES

The invention will now be described in further detail by way of the following examples,

### Example 1

To exemplify the wood terpene extract of the above invention, three different nature of wood terpene extracts were collected and compared together. Those wood terpene extracts are obtained from the same softwood origin. The softwood origin chosen, Pinus Pinaster, is the most common wood used in the woodworking industry in southern Europe. A first sample of wood terpene extract was obtained by a Kraft pulping process hereafter referenced as CST for Crude Sulfate Turpentine, a second sample of wood terpene extract was obtained by a tapping process hereinafter referenced as GT for Gum Turpentine (both processes are well known by the man of the art) and the third wood terpene extract hereinafter referenced as LST (for Low Sulfur Turpentine) was obtained by the process according to the invention, i.e. a liquid wood extract obtained from the woodwork industries is partially evaporated, consecutively totally condensed and finally separated from the water by simple decantation to get a terpenes oil mixture called LST.

The three terpene extracts were analyzed by gas chromatography (GCFID) on an Agilent 8890 equipped with a polar column such as CPWAX 57CB (25 m/0.25 mm/0.20 μm).

The total sulfur content was obtained for the wood terpenes extracts from tapping process and the above invention process by Fluorescence UV on a Sulfur Analyser Antek Multitek NT-HS (respecting ASTM D 5453). The total sulfur content for the wood extract terpene from kraft pulping process was obtained by Fluorescence X on a Horiba SLFA 6800 (respecting ASTM D 4294).

The flash point was measured by a Eraflash apparatus respecting ASTM D 3828.

The identification of the terpene was done by using a mass spectrometer equipped with an apolar column (such as DB5ms) and the quantification was done by GCFID equipped with a polar (such as ZBwax or CPWax 57CB) column. This orthogonal LRI procedure was used by comparison of the experimental values and the theoretical values compared to standard when available.

The results obtained are presented in table 1 bellow

TABLE 1

| | | | PINUS | PINUS | PINUS |
|---|---|---|---|---|---|
| | | | PINASTER | PINASTER | PINASTER |
| | | | CST | GT | LST |
| NON | % Alpha- | GC FID | 60.2 | 69.8 | 63.9 |
| OXYGENATED | pinene | | | | |
| MONOTERPENES | % Beta-pinene | GC FID | 16.3 | 18.6 | 19.7 |
| | % Delta-3- | GC FID | 0.2 | 0.2 | 0.1 |
| | carene | | | | |
| | % Myrcene | GC FID | 0.6 | 0.7 | 0.8 |
| | % Dipentene | GC FID | 2.4 | 2.5 | 2.9 |
| | % Beta- | GC FID | 0.9 | 0.9 | 0.6 |
| | phellandrene | | | | |
| | % p-cymene | GC FID | 0.2 | 0.1 | 0.1 |
| | % Terpinolene | GC FID | 2 | 0.6 | 1.1 |
| | % Other non | GC FID | 3.1 | 2.8 | 2.3 |
| | oxygenated | | | | |
| | monoterpenes | | | | |
| % Other chemicals | | GC FID | 14.1 | 3.8 | 8.5 |
| | Total sulfur | Fluorescence | 12400 | <10 | <10 |
| | content (ppm) | X | | | |
| | Flash Point | | <20° C. | 39° C. | 39° C. |
| | (° C.) | | | | |

The three extracts presented in Table 1 show very high concentrations of non-oxygenated monoterpenes, 85.9% for CST, 91.5% for LST and 96.2% for GT. Alpha pinene, beta-pinene and dipentene are the three most present terpenes considering the same wood origin of those wood terpene extracts. Nevertheless, the relative percentage of alpha pinene regarding the entire non-oxygenated monoterpenes is similar in CST (70.0%) and LST (69.8%) and higher in GT (72.6%). Furthermore, the relative percentage of beta pinene is similar in CST (19.0%) and GT (19.3%) but higher in LST (21.5%).

GT and LST show the highest concentrations in non-oxygenated monoterpenes. Indeed, due to its low content of other chemicals (3.8%), GT is the most interesting extract for recovering only non-oxygenated monoterpenes (96.2%).

The main components of the “other chemicals” mentioned in table 1 are terpenic compounds of higher molecular weight such as oxygenated monoterpenes, sesquiterpenes, diterpenes, but also if the conditions of extraction are stringent, some wood biomass thermal degradation compounds such as aromatic phenolic compounds; e.g. 4-propylphenol, 4-ethylguaiacol, methyleugenol. The wood biomass thermal degradation compounds are found in higher concentration in CST. By comparing the three extracts, GT shows a very low concentration of other chemicals. Such low content does not allow an economical route to separate and/or concentrate valuable terpenic compounds of higher molecular weight for their use as raw materials at an industrial level.

To the opposite CST shows the higher content of higher molecular weight terpenic compounds. Nevertheless, in CST extract, the compounds found in “other chemicals” are enriched also in mixture of sulfur compounds. This high concentration of sulfur compounds is due to the use of sodium soda and sodium sulfide to generate sodium sulfide (Na2S) during Kraft pulping process. The sulfur compounds of the CST identified are mainly methylmercaptan and dimethylsulfide, dimethyldisulfide, 1-(methylthio) ethanethiol, thiophene, formyl-methylthiophene and propionylthiophene.

In addition, to lowered flash point and safety concerns, the presence of such sulfur compounds in high concentration (12400 ppm) in CST required specific purification stages; i.e. desulfurization steps; such as distillations and chemical reactions such as oxydation with peracetic acid (see Environmental technology and Innovation 18(21), 100628, 2020) with hypochlorites (see Bioresources 16(4), 8098-8110, 2021) or treatment with modified activated carbon (CN104449395). All those well-known methods impact significantly the overall costs of the resulting alpha pinene, beta pinene extracts, and caryophyllene, longifolene and humulene extract obtained. A similar observation was done for extraction and purification of terpene alcohols.

Consequently the use of CST for extracting alpha pinene and beta pinene, terpene alcohols such as terpineol or sesquiterpenes such as caryophyllene, longifolene and humulene for a potential use as raw material for further chemical synthesis does not allow an economical route for an industrial use.

LST shows a very advantageous composition as for recovering non-oxygenated monoterpenes (close to 91.5%) and also for the other chemicals such as sesquiterpenes (8.5%). The latter represents more than twice than level found in GT.

As during the process according to the invention not any chemicals are used, a very low concentration of sulfur compounds, less than 10 ppm, was found. As a result, the LST flash point is higher than CST and similar to GT, allowing safer operating conditions for production, storage and shipment. In addition, these sulfur compounds can be easily removed within usual turpentine purification processes. Consequently, not only the LST extract is rich with non-oxygenated monoterpenes and contains a substantial amount of higher molecular weight terpenic compounds, but purification of all these compounds is easily possible for their use as is or as a building block in a subsequent chemical synthesis.

### Example 2

In order to better identify the other chemicals found in GT and LST of Example 1, an additional study has been done and the results obtained are presented in table 2.

The identification of the compounds was done by using a mass spectrometer equipped with an apolar column (such as DB5ms) and the quantification was done by GCFID equipped with a polar (such as ZBwax or CPWax 57CB) column. This orthogonal LRI procedure was used by comparison of the experimental values and the theoretical values compared to standard when available.

Table 2 shows the compounds identified in the LST and GT extracts from the fraction above “other chemicals”.

TABLE 2

| | | PINUS | PINUS |
|---|---|---|---|
| | | PINASTER | PINASTER |
| | | GT | LST |
| MAIN | % (—) Borneol | 0.42 | 0.58 |
| OTHER | % (—) Terpinen-4-ol | 0.09 | 0.08 |
| CHEMICALS | % α-Terpineol | 0.51 | 0.61 |
| THAN | % Fenchol | 0.02 | traces |
| NON | % Longifolene | 0.83 | 1.94 |
| OXYGENATED | % Caryophilene | 1.21 | 3.1 |
| MONOTERPENES | % Humulene | 0.15 | 0.46 |
| | % α-muurolene | 0.04 | 0.31 |
| | % Longicyclene | 0.09 | 0.14 |
| | % α-longipinene | 0.02 | 0.05 |
| | % α-copaene | traces | 0.02 |
| | % Caryophylene oxide | traces | 0.04 |

As presented in table 2, between GT and LST, the main higher molecular weight terpenic compounds are terpenes alcohols and sesquiterpenes.

The main terpenes alcohol are alpha-terpineol, fenchol, borneol and terpinen-4-ol. The sesquiterpenes are longifolene, caryophyllene, longipinene, longicyclene, humulene and alpha-muurolene.

It should be noticed that to the contrary of CST extracts, in GT and in LST, no wood thermal degradation compound has been detected. This confirm that the conditions provided under the process of the invention reduce the degradation of the lignocellulosic biomass making the LST extract totally comparable to GT to this extent.

The absence of such degradation compounds reduces complexity of any upstream process prior to the uses of the terpenic extractives as raw materials.

In comparison, LST contains more than 20% of terpenes alcohol than GT. Furthermore the quantity of alpha-Terpineol (the most valuable terpene alcohol) is effectively 20% more present in LST than GT.

Similarly, the higher molecular weight terpenic compounds are more than 200% more present in LST than GT. Among them Longifolene and Caryophyllene being the most interesting sesquiterpenes, are effectively more than 200% more present in LRT than in GT.

Consequently, the combination of expected very significant concentrations of non-oxygenated monoterpenes with unexpected quite significant concentration of higher molecular weight terpenic compounds notably sesquiterpenes allows LST to have a unique and valuable chemical composition profile. Therefore, contrary to CST and GT, LST extract can be used as an ecofriendly chemical free, easy to handle [not inflammable and not toxic], easily accessible (purification/enrichment) source of biosourced building blocks/raw material for F&F industry as for non-oxygenated monoterpenes notably alpha-pinene, beta-pinene and dipentene, oxygenated monoterpenes more particularly terpene alcohol as terpineols and for sesquiterpenes typically caryophyllene, longifolene, humulene.

1. A liquid wood extract comprising:
a) between 50 and 95% (wt %) of at least one non-oxygenated monoterpene,
b) between 5 and 30% (wt %) of at least one terpene of higher molecular-weight than non-oxygenated monoterpenes,
c) less than 0.1% (wt %) of at least one wood biomass thermal degradation compound, and
d) a sulfur content of less than 1000 ppm.

2. The liquid wood extract according to claim 1, wherein said at least one terpene of higher molecular-weight than non-oxygenated monoterpenes has a molecular-weight of more than 140 g/mol and/or is selected from the group consisting of oxygenated monoterpenes, diterpenes, sesquiterpenes, and mixtures thereof.

3. The liquid wood extract according to claim 1, wherein said at least one terpene of higher molecular-weight than non-oxygenated monoterpenes is at least one oxygenated monoterpene selected from the group consisting of monoterpenes alcohols, monoterpene epoxides, and mixtures thereof and/or at least one diterpene selected from the group consisting of a dicyclic diterpene, a tricyclic diterpene, and mixtures thereof.

4. The liquid wood extract according to claim 1, wherein said at least one terpene of higher molecular-weight than non-oxygenated monoterpenes is at least one sesquiterpene selected from the group consisting of acyclic sesquiterpene, cyclic sesquiterpene, and mixtures thereof.

5. The liquid wood extract according to claim 1, wherein said at least one non-oxygenated monoterpene is selected from the group consisting of a bicyclic non-oxygenated monoterpene, a monocyclic non-oxygenated monoterpene, an acyclic non-oxygenated monoterpene, and mixtures thereof.

6. The liquid wood extract according to claim 1, wherein said at least one non-oxygenated monoterpene is
at least one bicyclic non-oxygenated monoterpene selected from the group consisting of α-Pinene, β-Pinene, Camphene, delta-3-Carene, bornylene, sabinene, thujene, Carane, each being in the form of any one of their stereoisomers, and a mixture thereof; and/or
at least one acyclic non-oxygenated monoterpene selected from the group consisting of Myrcene, ocimene, allo-ocimene, Citronellene, each being in the form of any one of their stereoisomers, and a mixture thereof; and/or
at least one monocyclic non-oxygenated monoterpene selected from the group consisting of Limonene, Dipentene, Isolimonene, p-Menthane, 1-p-Menthene, 3-p-Menthene, α-Terpinene, γ-Terpinene, Terpinolene, α-Phellandrene, β-phellandrene, p-Cymene, each being in the form each in the form of any one of their stereoisomers, and a mixture thereof.

7. The liquid wood extract according to claim 1, wherein said at least one wood biomass thermal degradation compound is any of:
at least one cellulose-derived decomposition product selected from the group consisting of hydroxymethyl furfural, levoglucosan, cellobiose, anhydroglucose derivatives, acetaldehyde, methanol, glyoxal, acrolein, each being in the form of any one of their stereoisomers, and a mixture thereof, and/or
at least one hemicellulose-derived decomposition product selected from the group consisting of furan, furan derivatives, furfuraldehyde, and furfuryl alcohol, and/or
at least one lignin-derived decomposition product selected from the group consisting of phenol, phenol derivatives, cresol, catechol, eugenol, methyleugenol, guaiacol, 4-propylphenol, 4-ethylguaiacol, syringol, p-hydroxyphenolic hydroxy methoxy toluene, hydroxy methoxy ethyl benzene, hydroxy methoxyvinyl benzene, hydroxy methoxy propyl benzene, dimethoxy phenol, hydroxy dimethoxy toluene, hydroxy dimethoxy ethyl benzene, hydroxy dimethoxy propyl benzene, pyrocatechol, benzofuran, dibenzofuran, vanillin, each being in the form of any one of their stereoisomers, and a mixture thereof, and/or a mixture thereof.

8. The liquid wood extract according to claim 1, comprising:
less than 0.05% (wt %) of at least one wood biomass thermal degradation compound; and/or
a sulfur content of less than 200 ppm; and/or
5 and 20% (wt %) of at least one terpene of higher molecular-weight than non-oxygenated monoterpenes

9. The liquid wood extract according to claim 1, wherein said at least one oxygenated monoterpene is at least one monocyclic monoterpene alcohol.

10. A process for producing a liquid wood extract comprising:
a. providing wood logs mix comprising hardwood and softwood, with more than 50% of softwood,
b. cutting or chipping or shredding the wood logs in strands or chips,
c. applying a first steam treatment on the wood strands or chips in such a way that the steam is passed over the wood stands or chips at a temperature between 50° C. and 120° C. and at a pressure between 0.1×105 Pa and 4×105 Pa,
d. applying a first compression step of the wood strands or chips at a pressure of between 7×105 Pa and 15×105 Pa and by adding water to the wood strands or chips at a temperature of between 10 to 40° C., to obtain pre-softened wood strands or chips and to collect a first compression extract,
e applying an evaporation step to the first compression extract by evaporating more than 15% of the first compression extract to generate a steam enriched in terpenic compounds,
f. condensing the steam enriched in terpenic compounds, optionally combined with steam collected from the first steam treatment process, to obtain a condensed phase, and
g. applying a separation phase to said condensed phase by treating the condensed phase preferably by gravimetry decantation and/or centrifugation to obtain a liquid wood extract.

11. The process according to claim 10 wherein the process further comprises:
second steam treatment that is applied to the pre-softened wood strands or chips in such a way that the steam is passed over the pre-softened wood strands or chips at a temperature between 150° C. and 220° C., at a pressure between 7×105 Pa and 17×105 Pa, and
a second compression step applied following the second steam treatment at a pressure of between 7×105 Pa and 15×105 Pa to obtain softened wood strands or chips and to collect a second compression extract.

12. The process according to claim 10 wherein said process further comprises a refining step applied by passing a steam over the pre-softened wood stands or chips or over the softened wood stands or chips at a temperature between 150° C. and 220° C., at a pressure between 7×105 Pa and 15×105 Pa.

13. The process according to claim 11 wherein said condensed phase also comprises the steam collected from the second steam treatment and/or the refining step.

14. A process for obtaining a perfumery, cosmetic, pharmaceutic, nutraceutical, antimicrobial agrochemical and/or chemical ingredient comprising the step of obtaining the liquid wood extract according to the process of claim 10.

15. A method of using the liquid wood extract according to claim 1, the method comprising using the liquid wood extract as an active compound in perfumery, cosmetic, pharmaceutic, nutraceutical, antimicrobial, agrochemical and/or chemical compositions or for obtaining an active compound for a perfumery, cosmetic, pharmaceutic, nutraceutical, antimicrobial, agrochemical or chemical composition.

16. The liquid wood extract according to claim 1, wherein said at least one terpene of higher molecular-weight than non-oxygenated monoterpenes is at least one sesquiterpene selected from the group consisting of farnesene, longifolene, longicyclene, longipinene caryophyllene, humulene, murolene, each in the form of any one of their stereoisomers, and a mixture thereof.

17. The liquid wood extract according to claim 1, wherein said at least one oxygenated monoterpene is at least one monocyclic monoterpene alcohol selected from the group consisting of terpineol, estragole, anethole, borneol, each being in the form of any one of their stereoisomers, and a mixture thereof.

18. The process according to claim 10 wherein the wood logs mix comprising hardwood and softwood comprises more than 70% of softwood.

19. The process according to claim 10, wherein applying a separation phase to said condensed phase by treating the condensed phase is performed by gravimetry decantation and/or centrifugation to obtain a liquid wood extract.
